(19) United States
(12) Patent Application Publication
(10) Pub. No.: US 2001/0008727 A1
(43) Pub. Date: Jul. 19, 2001

(54) Lithium polymer battery

(76) Inventor: Hun-goo Cho, Chungcheongnam-do (KR)

Correspondence Address: LEYDIG VOIT & MAYER, LTD, 700 THIRTEENTH ST. NW, SUITE 300, WASHINGTON, DC, 20005-3960, US

(21) Appl. No.: 09/758,244

(22) Filed: Jan. 12, 2001

(30) Foreign Application Priority Data
Jan. 16, 2000 (KR) 2000-518

(51) Int. Cl. H01M 4/62; H01M 10/40; H01M 6/18

(52) U.S. Cl. 429/217; 429/232; 429/306; 429/231.95

(57) ABSTRACT

A lithium polymer battery is provided. The lithium polymer battery includes a positive electrode plate having a positive electrode current collector and a positive electrode sheet having a positive electrode active material fixed to at least one plane of the positive electrode current collector as a main component, a negative electrode plate having a negative electrode current collector and a negative electrode sheet having a negative electrode active material fixed to at least one plane of the negative electrode current collector as a main component, a separator interposed between the positive electrode plate and the negative electrode plate, for isolating the positive and negative electrode plates from each other, and coating means interposed between the positive electrode current collector and the positive electrode sheet and between the negative electrode current collector and the negative electrode sheet, for increasing the adhesiveness of the current collectors and the sheets.

### BACKGROUND OF THE INVENTION

1. Field of the Invention

The present invention relates to a lithium polymer battery having improved structures of positive and negative electrode plates.

2. Description of the Related Art

In general, lithium secondary batteries are classified into liquid electrolyte batteries and polymer electrolyte batteries according to the kind of electrolytic solution. The batteries using liquid electrolyte are called lithium secondary batteries, and the batteries using polymer electrolyte are called lithium polymer batteries.

In particular, the lithium polymer batteries are excellent in safety and freedom of shape. Also, they are lightweight compared to other kinds of secondary batteries. Thus, much attention has been paid to miniaturized, lightweight lithium polymer batteries as components of portable electronic devices.

Referring to FIG. 1, a lithium polymer battery includes a battery unit 10 constructed by a positive electrode plate 11, a negative electrode plate 12, and a separator 13 interposed therebetween. The positive electrode plate 11 includes a positive electrode current collector 14 and a positive electrode sheet 15 adhered to the surface of the positive electrode current collector 14. The positive electrode current collector 14 is made of aluminum grid. The positive electrode sheet 15 includes a conductive agent, a plasticizer and a binder as well as a positive electrode active material such as lithium oxide.

The negative electrode plate 12 includes a negative electrode current collector 16 and a negative electrode sheet 17 adhered to the surface of the negative electrode current collector 16. The negative electrode current collector 16 is made of copper grid. The negative electrode sheet 17 includes a conductive agent, a plasticizer and a binder as well as a negative electrode active material such as carbon materials.

In the battery unit 10, adhesion between the positive electrode current collector 14 and the positive electrode sheet 15 and adhesion between the negative electrode current collector 16 and the negative electrode sheet 17 are not easy to accomplish. Thus, each separate coating layer is formed on the positive and negative electrode current collectors 14 and 16.

In other words, in order to increase adhesiveness, adhesive resin made of copolymer or monopolymer is coated on the positive and negative electrode current collectors 14 and 16. Also, in order to improve conductivity, conductive powder such as acetylene black is coated on the positive and negative electrode current collectors 14 and 16. Then, the positive electrode sheet 15 and the negative electrode sheet 17 are formed on both surfaces of the positive and negative electrode current collectors 14 and 16.

The following problems involve in formation of the coating layers.

First, a separate coating apparatus is necessary for coating the adhesive resin and conductive powder on the positive and negative electrode current collectors 14 and 16. The coating process using the coating apparatus is complex.

Second, since the coating layers are formed on the surfaces of the positive and negative electrode current collectors 14 and 16 by a spray method, there may be a difference in the thickness, which makes it difficult to attain uniformity in quality.

### SUMMARY OF THE INVENTION

To solve the above problems, it is a first object of the present invention to provide a lithium polymer having an improved structure of a coating layer formed for improving adhesion between a positive electrode plate and a negative electrode plate connected to a positive electrode current collector and a negative electrode current collector, respectively.

To achieve the first object, there is provided a lithium polymer battery including a positive electrode plate having a positive electrode current collector and a positive electrode sheet having a positive electrode active material fixed to at least one plane of the positive electrode current collector as a main component, a negative electrode plate having a negative electrode current collector and a negative electrode sheet having a negative electrode active material fixed to at least one plane of the negative electrode current collector as a main component, a separator interposed between the positive electrode plate and the negative electrode plate, for isolating the positive and negative electrode plates from each other, and coating means interposed between the positive electrode current collector and the positive electrode sheet and between the negative electrode current collector and the negative electrode sheet, for increasing the adhesiveness of the current collectors and the sheets.

Also, the coating means is preferably a thin film containing adhesive resin and a conductive agent.

Further, the adhesive resin interposed between the positive electrode current collector and the positive electrode sheet is at least one selected from the group consisting of poly(ethylene-acrylate) copolymer and pyrrole monomer.

Preferably, the conductive agent interposed between the positive electrode current collector and the positive electrode sheet is acetylene black.

Also, the adhesive resin interposed between the negative electrode current collector and the negative electrode sheet is preferably poly(vinylidene fluoridehexafluoropropylene) copolymer.

The conductive agent interposed between the negative electrode current collector and the negative electrode sheet is preferably acetylene black.

Further, the coating means may be formed by dispersing the adhesive resin and the conductive agent in each solvent to obtain emulsion and casting the emulsion.

### BRIEF DESCRIPTION OF THE DRAWINGS

The above objects and advantages of the present invention will become more apparent by describing in detail a preferred embodiment thereof with reference to the attached drawing in which:

FIG. 1 is a schematic sectional view partially showing a conventional battery unit;

FIG. 2 is an exploded perspective view of a general battery; and

FIG. 3 is an enlarged perspective view of a battery unit according to a preferred embodiment of the present invention.

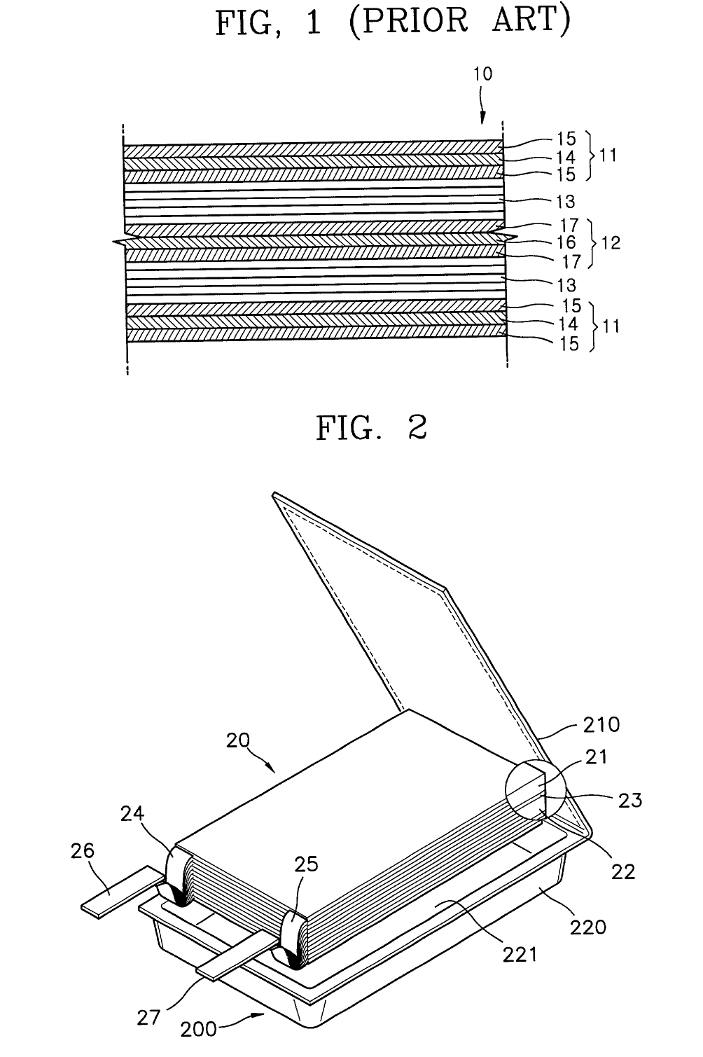

### DESCRIPTION OF THE PREFERRED EMBODIMENT

A lithium polymer battery according to a preferred embodiment of the present invention will now be described with reference to the accompanying drawings.

Referring to FIG. 2, a lithium polymer battery includes a battery unit 20 and a case 200.

The battery unit 20 includes a plurality of positive electrode plates 21, negative electrode plates 22 and separators 23 interposed between each of the positive and negative electrode plates 21 and 22. A positive electrode tap 24 and a negative electrode tap 25 are drawn out from one edge of each of the positive and negative electrode plates 21 and 22. The positive and negative electrode taps 24 and 25 are combined and welded to each electrode. The positive and negative electrode taps 24 and 25 are welded to a positive electrode terminal 26 and a negative electrode terminal 27 electrically connected to external terminals, respectively.

The case 200 includes an upper case part 210 and a lower case part 220 hermetically sealed with the upper case part 210. A space 221 for accommodating the battery unit 20 is provided in the lower case part 220.

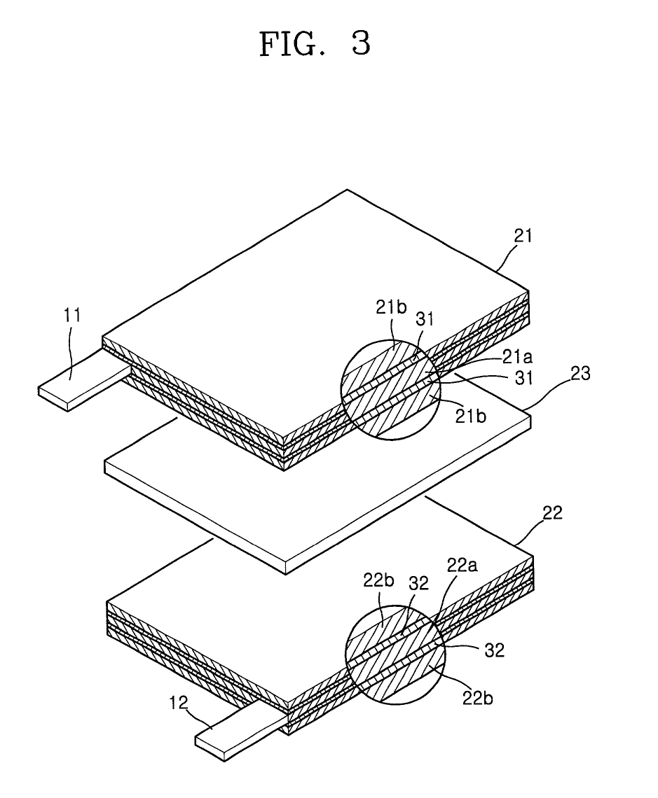

The positive and negative electrode plates 21 and 22 featuring the present invention are shown in FIG. 3.

The positive electrode plate 21 includes a positive electrode current collector 21a and a positive electrode sheet 21b adhered to at least one plane of the positive electrode current collector 21. The positive electrode current collector 21a is made of aluminum grid. The positive electrode sheet 21b is slurry formed by adding a conductive agent, a plasticizer and a binder to a positive electrode active material which is at least one oxide selected from the group consisting of lithium group oxide, nickel group oxide and manganese group oxide.

The negative electrode plate 22 includes a negative electrode current collector 22a and a negative electrode sheet 22b adhered to at least one plane of the negative electrode current collector 22. The negative electrode current collector 22a is made of copper grid. The negative electrode sheet 22b is formed by adding a conductive agent, a plasticizer and a binder to a negative electrode active material made of carbon materials.

Here, each separate coating means is interposed between the positive electrode current collector 21a and the positive electrode sheet 21b and between the negative electrode current collector 22a and the negative electrode sheet 22b in order to improve adhesiveness and conductivity therebetween.

In other words, a positive electrode coating film 31 is interposed between the positive electrode current collector 21 a and the positive electrode sheet 21b. The positive electrode coating film 31 contains adhesive resin made of copolymer or monopolymer having good adhesiveness, for example, poly(ethylene-acrylate) copolymer or pyrrole monomer, and acetylene black having good conductivity. The positive electrode coating film 31 is a thin film and is formed by a casting method.

Also, a negative electrode coating film 32 is interposed between the negative electrode current collector 22a and the negative electrode sheet 22b. The negative electrode coating film 32 contains adhesive resin made of poly(vinylidene fluoridehexafluoropropylene) (PVDF-HFP) copolymer, and acetylene black. The negative electrode coating film 32 is also formed by a casting method, like the positive electrode coating film 31. This will now be described in more detail.

In order to adhere the positive electrode current collector 21a to the positive electrode sheet 21b, the positive electrode current collector 21a is rinsed with distilled water and dried. Next, the positive electrode current collector 21a is etched in a 0.1 M sodium hydroxide (NaOH) solution for approximately 10 minutes.

Then, the positive electrode coating film 31 to be fixed t at least one plane of the positive electrode current collector 21a is fabricated. In other words, poly(ethylene-acrylate) copolymer or pyrrole monomer, and acetylene black which is a conductive agent are dispersed in a solvent such as alcohol to obtain emulsion, and the obtained emulsion is cast into a thin film, thereby fabricating the positive electrode coating film 31.

The thus-fabricated film 31 is fixed to the surface of the positive electrode current collector 21a by hot rolling.

The negative electrode plate 22 is fabricated in the same procedure as the positive electrode plate 21. In other words, the negative electrode current collector 22a made of copper grid is rinsed, dried and etched.

Also, the negative electrode coating film 32 to be fixed to at least one plane of the negative electrode current collector 22a is fabricated. In other words, poly(vinylidene fluoride-hexafluoropropylene) (PVDF-HFP) copolymer which is adhesive resin used for the negative electrode current collector 22a, acetylene black which is a conductive agent, and oxalic acid which is an additive for improving adhesiveness, are dissolved in a solvent such as acetone to obtain emulsion. Then, the obtained emulsion is cast into a thin film, thereby fabricating the negative electrode coating film 32. Next, the negative electrode coating film 32 is fixed to the surface of the negative electrode current collector 22a by hot rolling.

The positive electrode sheet 21b is fixed to the surface of the positive electrode current collector 21a having the positive electrode coating film 31 coated thereon by a laminating process. The negative electrode sheet 22b is also fixed to the surface of the negative electrode current collector 22a having the negative electrode coating film 32 coated thereon.

The thus-fabricated positive and negative electrode plates 21 and 22 are fixed to each other with the separator disposed therebetween, by applying heat and pressure thereto.

Subsequently, the plasticizer contained in the positive and negative electrode sheets 21b and 22b are extracted and then electrolyte is impregnated into the space produced by extracting the plasticizer. Then, the battery unit 20 is inserted into a space 221 in the lower case part (220 of FIG. 2) and the upper case part 210 and the lower case part 220 are hermetically sealed, thereby completing a battery.

As described above, according to the lithium polymer battery of the present invention, when a positive electrode current collector and a positive electrode sheet, or a negative electrode current collector and a negative electrode sheet, are adhered to each other, adhesive resin or a conductive coating film therebetween is interposed therebetween to then be fixedly secured. Thus, a thickness difference due to the adhesive resin and the conductive agent added for facilitating adhesion of a current collector and an electrode sheet can be prevented. Also, since the current collectors and sheets can be fabricated using conventional laminating equipments, the fabrication process is simplified.

Although the present invention has been described with reference to the preferred examples, the foregoing disclosure should be interpreted as illustrative only and it should be understood that various modifications and variations can be easily made by those skilled in the art without departing from the spirit of the invention. Accordingly, a true scope and spirit of the invention should be defined by the following claims.

What is claimed is:

1. A lithium polymer battery comprising:
a positive electrode plate having a positive electrode current collector and a positive electrode sheet having a positive electrode active material fixed to at least one plane of the positive electrode current collector as a main component;
a negative electrode plate having a negative electrode current collector and a negative electrode sheet having a negative electrode active material fixed to at least one plane of the negative electrode current collector as a main component;
a separator interposed between the positive electrode plate and the negative electrode plate, for isolating the positive and negative electrode plates from each other; and
coating means interposed between the positive electrode current collector and the positive electrode sheet and between the negative electrode current collector and the negative electrode sheet, for increasing the adhesiveness of the current collectors and the sheets.

2. The lithium polymer battery according to claim 1, wherein the coating means is a thin film containing adhesive resin and a conductive agent.

3. The lithium polymer battery according to claim 2, wherein the adhesive resin interposed between the positive electrode current collector and the positive electrode sheet is at least one selected from the group consisting of poly(ethyleneacrylate) copolymer and pyrrole monomer.

4. The lithium polymer battery according to claim 2, wherein the conductive agent interposed between the positive electrode current collector and the positive electrode sheet is acetylene black.

5. The lithium polymer battery according to claim 2, wherein the adhesive resin interposed between the negative electrode current collector and the negative electrode sheet is poly(vinylidene fluoride-hexafluoropropylene) copolymer.

6. The lithium polymer battery according to claim 2, wherein the conductive agent interposed between the negative electrode current collector and the negative electrode sheet is acetylene black.

7. The lithium polymer battery according to claim 2, wherein the coating means is formed by dispersing the adhesive resin and the conductive agent in each solvent to obtain emulsion and casting the emulsion.
